(19) United States
(12) Patent Application Publication
(10) Pub. No.: US 2019/0345360 A1
(43) Pub. Date: Nov. 14, 2019

(54) POLYUREA COATING OF SURFACES FOR LEAK PROTECTION

(71) Applicants: TECHNION RESEARCH & DEVELOPMENT FOUNDATION LIMITED, Haifa (IL); SELA INDUSTRIAL MAINTENANCE 2006 LTD., Haifa (IL)

(72) Inventors: Benjamin DANINO, Nesher (IL); Daniel RITTEL, Haifa (IL); Nitai DRIMER, Habonim (IL)

(21) Appl. No.: 16/466,415

(22) PCT Filed: Dec. 4, 2017
(86) PCT No.: PCT/IL2017/051312

§ 371 Date: Jun. 4, 2019

Related U.S. Application Data
(60) Provisional application No. 62/429,818, filed on Dec. 4, 2016.

(51) Int. Cl. C09D 175/02; C09D 5/00; B63B 59/00

(52) U.S. Cl. CPC C09D 175/02; B63B 59/00; C09D 5/002

(57) ABSTRACT

A watercraft comprising a hull, and a polymer layer disposed over an inner side of the hull. The polymer layer has a thickness of between 1 to 5 millimeters, and an elasticity of between 100% and 1200% elongation. The watercraft comprises the hull and the polymer layer, where the interface layer adheres the polymer layer to the inner side of the hull at an adhesion strength of between 0.5 to 1.2 mega-Pascal (MPa).

### CROSS-REFERENCE TO RELATED APPLICATIONS

This application claims the benefit of priority of U.S. Provisional Patent Application No. 62/429,818, filed on Dec. 4, 2016. The content of the above document is incorporated by reference in its entirety as if fully set forth herein.

### BACKGROUND

The invention, in some embodiments thereof, relates to the field of leak protection.

Planning boats are designed to rise above and glide along the waves, where the weight of the boat is predominantly supported by hydrodynamic lift instead of buoyancy. At high speeds the waves impact the hull of the boat with high force, to propel the boat out of the water. The hull design of planning boat is usually different, and specifically designed to increase the hydrodynamic lift. Many planning boats use Aluminum 5083 alloy plates for the hull material, as these plates are resistant to corrosive attack by seawater, and provide good strength after welding.

Polyurea and other polymer coatings are used to coat the outer surface of boats to increase waterproofing and prevent damage to the hull of the boat. For example, polyurea is used to cover the outer surface of fishing boats to prevent water penetration. For example, polyurea is used to cover the outer surface jet boat hulls, instead of polyethelyne sheet liners, to protect the hull from impact damage from solid objects in shallow waters.

Polyurea-metal composites are used for impact protection against penetration by high velocity projectiles, as described by Mohottia et al. in “Polyurea coated composite aluminum plates subjected to high velocity projectile impact” published in Materials & Design Volume 52, December 2013, Pages 1-16.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a watercraft comprising a hull, and a polymer layer disposed over an inner side of the hull. The polymer layer has a thickness of between 1 to 5 millimeters, and an elasticity of between 100% and 1200% elongation. The watercraft comprises the hull and the polymer layer, where the interface layer adheres the polymer layer to the inner side of the hull at an adhesion strength of between 0.5 to 1.2 mega-Pascal (MPa).

There is provided, in accordance with an embodiment, an article of manufacture comprising a partition and a polymer layer disposed over one surface of the partition, the polymer layer having a thickness of between 1 to 5 millimeters, and an elasticity of between 100% and 600% elongation. The article of manufacture comprises an interface layer disposed between the partition and the polymer layer, where the interface layer adheres the polymer layer to the inner side of the partition at an adhesion strength of between 0.5 to 1.2 MPa.

There is provided, in accordance with an embodiment, a structure comprising a partition configured to prevent a liquid from breaching the structure, the partition having an inner side protected from the liquid. The structure comprises a polymer layer disposed over the inner of the partition, the polymer layer having a thickness of between 1 to 5 millimeters, and an elasticity of between 100% to 600% elongation. The structure comprises an interface layer disposed between the inner side of the partition and the polymer layer, where the interface layer adheres the polymer layer to the inner side of the partition at an adhesion strength of between 0.5-1.2 MPa.

There is provided, in accordance with an embodiment, an article of manufacture comprising a substrate, a polymer coating connecting to an inner surface of the substrate, and a connecting layer between the substrate and the polymer coating. The polymer coating comprises at least 1 mm in thickness, and an elasticity of between 100% to 600% elongation, and an adhesion strength between the substrate and the polymer coating is at most 1.2 MPa.

In some embodiments, the substrate is an aluminum plate.

In some embodiments, the aluminum plate is an aluminum alloy 5083 plate.

In some embodiments, the polymer coating is a polyurea coating.

In some embodiments, the polymer coating comprises a tensile strength of between 5 and 60 Newtons per millimeter square as measured by DIN Standard 53504.

There is provided, in accordance with an embodiment, method for protecting a hull from a breach, comprising an action of priming the inner surface of a hull. The method comprises an action of applying a polymer coating to the inner surface, over the priming, where the polymer coating comprises at least 1 mm in thickness, and an elasticity of between 100% to 600% elongation. When an impact causes a breach of the hull, the priming and the polymer coating are configured to receive a fluid between the polymer coating and the hull. A portion of the polymer coating is detached from the hull thereby forming a blister. The fluid in the blister is prevented from entering an inner space defined by the polymer coating and the hull. The priming produces an adhesion strength between the inner surface and the polymer coating is at most 1.2 mega-pascal (MPa).

In some embodiments, the priming comprises one or more of abrading the inner surface to between 10 to 25 micrometer depth, applying a wash primer of at least 30 micrometers, and applying a paint coating of at least 30 micrometers.

In some embodiments, the preventing comprises an equilibrium of forces acting on the blister, where the equilibrium of forces comprises the force of pressure inside the blister from the fluid, the force of adhesion of the polymer coating to the inner surface, and the force of surface tension of the polymer coating on the blister.

There is provided, in accordance with an embodiment, a polyurea coating for use in preventing water from breaching a hull of a watercraft. The polyurea coating is located on an inner surface of a hull of the watercraft. The polyurea coating comprises at least 1 mm in thickness, an elasticity of between 100% to 600% elongation, and an adhesion strength to the inner surface of at most 1.2 mega-pascal (MPa).

In addition to the exemplary aspects and embodiments described above, further aspects and embodiments will become apparent by reference to the figures and by study of the following detailed description.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Exemplary embodiments are illustrated in referenced figures. Dimensions of components and features shown in the figures are generally chosen for convenience and clarity of presentation and are not necessarily shown to scale. The figures are listed below.

In the drawings:

FIG. 1 shows a schematic representation of a cross section view of an aluminum plate coated with polyurea after impact causes penetration of water through the hull; and

FIG. 2 shows a schematic illustration of mechanical forces acting on the polyurea separation edge.

### DETAILED DESCRIPTION

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The invention, in some embodiments thereof, relates to material science and, more particularly, but not exclusively, to polyurea coated surfaces for leak protection.

Disclosed herein are articles and method for applying a coating of polyurea on the inner surface of a partition of an object or structure, such as on the inside of a boat hull and the like, so that the when the partition is breached from the outside side, the coating selectively detaches from the inner surface of the plate to form a blister and prevent the fluids outside from entering the object. Since the coating is on the inside of the object, away from the outside impact surface, the coating remains intact when a blister forms and prevents the fluid from entering by having a surface adhesion strength matched to the elongation and surface tensile strength of the coating. The interface layer between the coating and the inner surface is designed and prepared so that the adhesion strength of the coating is less than the threshold needed to form a blister. For example, the tensile strength of the coating is between 5 and 60 Newtons per millimeter square as measured by DIN Standard 53504.

Optionally, the object is a planning boat. The object or structure may be any partition between two fluids, where the coating may be used to prevent the fluid from one side of the partition from entering the other side of the partition using a coating on the other side of the partition, away from the prevented fluid, configured to detach from the partition and form a blister. For example, a submarine, a vessel in a hostile fluid environment, an underwater structure, an underwater observatory, a water tank, and/or the like.

The advantages of coating the inner surface instead of the outer surface are to allow the structure to be made lighter, more flexible, easy application while in service, easy visual inspection to see that a breach has occurred, easy repair, easy application, while in service, and protection of the coating from external impact and abrasion.

Optionally, the coating is a polymer with the characteristics of waterproofness, impact resistance, abrasion resistance, and the like, such as of similar specifications as polyurea.

Optionally, the coating is of a material comprising polyurea.

Optionally, the plate surface preparation, primer, and the like, are adapted to have a surface adhesion strength below a threshold. For example, the coating detaches from the plate surface when an external impact causes the plate to tear and outside fluids to enter a space between the plate and the coating, thereby forming a blister. The blister may prevent fluid from entering the object for enough time to allow the object to reach a repair facility. For example, if the boat hull is breached during sea travel the blister will prevent the boat from sinking before the boat reaches a harbor for repairing the hull.

For example, ASTM D4541 standard is used to measure the pull-off adhesion strength of the coating. For example, SSPC-PA 14 standard is used to prepare a substrate for coating and measure thickness of a polyurea coating layers. For example, pull off strength is between 0.01 and 10 mega-pascals (MPa), such as by measuring the average pull off strength of a large number of samples. For example, pull off strength is between 0.5 and 1.2 MPa so that a blister forms. For example, pull off strength is below 10 MPa, 7.5 MPa, 5 MPA, 2.5 MPa, or 1 MPA. For example, pull off strength is above 500 kilo-pascals (KPa), 100 KPa, or 50 KPA. A higher pull off strength results in a smaller blister with a smaller amount of fluid entering the boat and a lower pull off strength results in a larger blister with a large amount of fluid entering the boat. A smaller blister may be more rigid and a larger blister more compliant to the water pressure impulses resulting from the impact of waves on the hull.

A balance between the size of the blister, the surface yield strength of the polyurea coating, the allowable elongation of the polyurea coating, the water impact pressure impulses (resulting from the speed of the boat and the hull hitting the waves), and the size of the breach in the hull may determine if the blister will remain intact until the boat reaches a repair station. For example, the operational specification of the planning boat may determine the amount of time and speed of the boat that must be considered before a breach can be repaired. Thus, the coating mechanical properties, the adhesion interface mechanical properties, and the application of the article, such as forces on the outside of a boat hull, determine the balance of properties needed to form a blister. Optionally, the blister may be large enough to be visible.

The polymer coating allows the plate to be made thinner than boat standards allow by adding protection from sinking when a breach occurs. The thinner plates may also allow some flexibility to the hull so that higher planning speeds can be obtained. For example, planning boat structural standards are described in Registro Italiano Navale (RINA) Rules for the Classification of High-Speed Craft 2009, and National Technical Information Service (NTIS) U.S. Department of Commerce, Report SSC-439 2005. The standards describe the required plate thickness to be sufficient to make the boat hull structure rigid, including the distance between framework spans.

Optionally, the support frame for the plates has larger distances between struts than standards allow to increase the flexibility of the hull plates. Optionally, the coating prevents a fluid from breaching the object with the increased flexibility plates. For example, the increased flexibility absorbs some of the impact energy from the hull slamming into the waves, and dissipates the absorbed impact energy when the boat is between slamming waves.

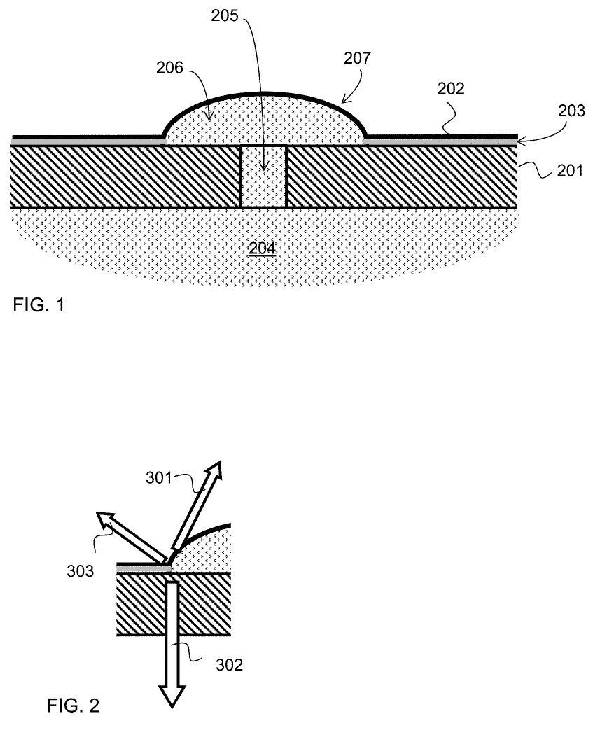

Reference is now made to FIG. 1, which is a schematic representation of a cross section view of an aluminum plate 201 coated with polyurea 202 after impact causes penetration of water through the hull. An impact may cause a breach 205 of the aluminum plate 201 hull, causing water pressure to push against polyurea coating 202. This causes coating 202 to separate from plate 201, by detaching an adhesive layer 203 between the two. As the outside water 204 enters the separated area 206, a blister is formed 207, eventually reaching a stable configuration. Water will enter and exit the blister as waves impact the hull, but the polyurea coating will prevent the water from entering the boat.

Reference is now made to FIG. 2, which is a schematic illustration of mechanical forces acting on a polyurea separation edge. When water enters a breach in a boat hull to a space between the hull and a polyurea coating, a blister is formed. The edge of the blister forms a closed curve, which when seen in cross section has three main forces acting along the edge. A force 303 of the water pressure pushing out on the polyurea coating, a force 302 of the surface adhesion between the polyurea and the hull, and a force 301 of the surface tension of the polyurea coating. As the blister gets larger, the edge length of the blister increase and force 301 of the surface tension of the polyurea coating decreases. Once the blister is of sufficient size relative to force 302 of surface adhesion, the forces will be stable and the blister will stop growing. As the boat impacts new waves, water will enter and exit the blister. When an especially strong wave impact is applied to the boat hull, the blister may increase slightly in size to a new maximum stable size.

Some benefits of the extra impact protection from a polyurea coating on the inside of the boat hull from a breach are to allow the hull plates to be thinner, thus making the boat lighter. This in turn allows the boat to plan higher and avoid larger impacts. The frame spars are also able to be further apart, thus decreasing the weight and fabrication costs as less welds will be needed. Also, the polyurea on the inside allows for corrosive isolation, such as protection from galvanic corrosion from metal parts that fall against the inside surface of the boat hull.

According to an aspect of some embodiments of the present invention there are provided processes of preparing an article of manufacture having the properties described herein. According to an aspect of some embodiments of the present invention there is provided a process of preparing an article of manufacture comprising a polymer coating applied on an article material, as described herein, which has a coating detachment strength below a threshold as described herein.

In some embodiments, the polymer coating is between 1 and 5 millimeters thick.

In some embodiments, the polymer coating has a surface expansion factor of between 100% to 600%. For example, the polymer coating has a surface expansion factor of 100%, 150%, 200%, or the like. For example, the polymer coating has a surface expansion factor of between 100% to 200%, or the like.

In some embodiments, the polymer coating has a surface expansion factor of 600% to 1200%.

In some embodiments, the article material is a plate.

In some embodiments, the plate is adapted to be used as a boat hull.

In some embodiments, the article material is aluminum plate.

In some embodiments, the article material is steel plate, titanium plate, or stainless steel plate.

In some embodiments, the article material is between 3 and 10 millimeters thick.

In some embodiments, the article material is primed before applying the polymer coating.

In some embodiments, the article material is primed with abrasive polishing.

In some embodiments, the article material is primed with roughening, abrasion, sanding, sand-blasting, and the like.

In some embodiments, the article material is primed to a depth between 10 and 25 micrometers. For example, the article material is primed by sandblasting to a roughness depth between 10 and 25 micrometers by variations in the air flow and abrasion material hardness, particle size, and/or the like.

In some embodiments, the article material is primed to a depth between 20 and 100 micrometers.

In some embodiments, the article material is primed with different adhesive techniques and materials, such as Alodine, Polyprime, wash primer, paint, and/or the like.

In some embodiments, the process consists essentially of the spray coating or dip coating procedures as described herein.

According to an aspect of some embodiments of the present invention there are provided articles of manufacture which comprise any one of the properties as described herein.

In some embodiments, there is provided an article of manufacture which comprises a solid material having deposited on an inner surface thereof a polymer coating as described herein.

In some embodiments, there is provided an article of manufacture which comprises a solid material having deposited on a surface thereof a polyurea coating as described herein, where an adhesive strength between the solid surface and the polyurea is in a range that is above a weak bond that would cause detachment without failure and below a strong bond that would tear the polyurea coating.

In some embodiments, there is provided an article of manufacture which is prepared by applying a priming coating onto the substrate as described herein onto a surface or a portion of surface thereof.

In some embodiments, there is provided an article of manufacture which is prepared by spray coating a polymer as described herein onto a surface or a portion of the surface thereof.

Exemplary articles of manufacture include, but are not limited to, boat hulls, buoys, floats, floating devices, marine vessels, submarines, and the like.

It is to be noted that herein throughout, any of the embodiments described herein for the dry-side polyurea coating may be used in combination with any of the embodiments described herein for a substrate, a process, an article of manufacture and a method, and that the present embodiments encompass all of these combinations, unless specifically indicated otherwise.

It is expected that during the life of a patent maturing from this application many relevant hydrocarbons will be developed and the scope of the term hydrocarbon is intended to include all such new technologies a priori.

In some embodiments, the polyurea layer is the cured reaction product of an isocyanate curing agent and a mixture of diamines having the general formula:

H₂N-Ph-(C═)—O—(CH₂—CH₂—CH₂—CH₂—O)ₙ—(C═O)-Ph-NH₂,

where Ph denotes a phenyl, and n is an integer, such as 1, 2, 3, or the like.

Polyurea may be a copolymer synthesized by reaction of an aliphatic diamine with a diisocyanate curing agent. The diisocyanate curing agent is usually chain extended with a diamine and/or a diol. The aliphatic diamine segment of the polymer is usually relatively soft and the diisocyanate segment of the polymer is relative hard. Chemical differences between the soft aliphatic diamine segments and the hard diisocyanate segments may cause the extended hard isocyanate segments to phase-separate from the soft segments to form hard domains that may act as physical cross links in the elastic matrix. The morphology of the phase-separated hard-segment domains may range from lamellae type stacks or platelets of isolated domains to long thread like regions that overlap or intersect, depending on quantity of precursors and polymerization conditions. The elastic and plastic deformation response at high strains involves the orientation of the soft and hard segments and is of interest for absorbing applications at various strain rates.

Optionally, the inner hull coating is a polymer having similar mechanical properties to polyurea, and configured to perform the methods described herein.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, metallurgical, marine, transportation, and fluid containment arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A watercraft comprising:
a hull;
a polymer layer disposed over an inner side of said hull, said polymer layer having:
a thickness of between 1 to 5 millimeters, and
an elasticity of between 100% and 1200% elongation; and
an interface layer disposed between said hull and said polymer layer, wherein said interface layer adheres said polymer layer to the inner side of said hull at an adhesion strength of between 0.5 to 1.2 mega-Pascal (MPa).

2. The watercraft according to claim 1, where the hull comprises an aluminum plate.

3. The article of manufacture according to claim 2, where the aluminum plate is an aluminum alloy 5083 plate.

4. The watercraft according to claim 1, where the polymer layer is a polyurea layer.

5. The watercraft according to claim 1, where the polymer layer comprises a tensile strength of between 5 and 60 Newtons per millimeter square as measured by DIN Standard 53504.

6. An article of manufacture comprising:
a partition;
a polymer layer disposed over one surface of said partition, said polymer layer having a thickness of between 1 to 5 millimeters, and an elasticity of between 100% and 600% elongation; and
an interface layer disposed between said partition and said polymer layer, wherein said interface layer adheres said polymer layer to the inner side of said partition at an adhesion strength of between 0.5 to 1.2 MPa.

7. The article of manufacture according to claim 6, where the partition is an aluminum plate.

8. The article of manufacture according to claim 7, where the aluminum plate is an aluminum alloy 5083 plate.

9. The article of manufacture according to claim 6, where the polymer layer is a polyurea layer.

10. The article of manufacture according to claim 6, where the polymer layer comprises a tensile strength of between 5 and 60 Newtons per millimeter square as measured by DIN Standard 53504.

11.-20. (canceled)

21. A method for protecting a hull from a breach, comprising:
priming the inner surface of a hull; and
applying a polymer coating to said inner surface, over the priming, wherein the polymer coating comprises at least 1 mm in thickness, and an elasticity of between 100% to 600% elongation;
wherein, when an impact causes a breach of said hull, said priming and said polymer coating are configured to:
receive a fluid between said polymer coating and said hull;
detach a portion of said polymer coating from said hull thereby forming a blister;
prevent the fluid in said blister from entering an inner space defined by said polymer coating and said hull;
wherein the priming produces an adhesion strength between said inner surface and said polymer coating is at most 1.2 MPa.

22. The method according to claim 21, wherein the priming comprises at least one of:
abrading the inner surface to between 10 to 25 micrometer depth,
applying a wash primer of at least 30 micrometers, and
applying a paint coating of at least 30 micrometers.

23. The method according to claim 21, wherein the preventing comprises an equilibrium of forces acting on the blister, wherein the equilibrium of forces comprises the force of pressure inside the blister from the fluid, the force of adhesion of the polymer coating to said inner surface, and the force of surface tension of the polymer coating on the blister.

24.-27. (canceled)
